(19) United States
(12) Patent Application Publication
(10) Pub. No.: US 2004/0130041 A1
(43) Pub. Date: Jul. 8, 2004

(54) Vapor-liquid contact tray and method employing same

(76) Inventors: Michael R. Resetarits, Depew, NY (US); Charles A. Griesel, Red Oak, TX (US); Johnny B. Riter, Wichita, KS (US); Ralph H. Weiland, Coalgate, OK (US)

Correspondence Address: SHOOK, HARDY & BACON LLP, 2555 GRAND BLVD, KANSAS CITY,, MO, 64108, US

(21) Appl. No.: 10/606,308

(22) Filed: Jun. 25, 2003

Related U.S. Application Data
(60) Provisional application No. 60/391,483, filed on Jun. 25, 2002.

(51) Int. Cl. B01F 3/04

(52) U.S. Cl. 261/79.2; 261/114.1

(57) ABSTRACT

A vapor-liquid contact tray (26) is provided with a tray deck (28) having at least one opening for removing liquid from an upper surface of the tray deck and a plurality of vapor passages (44) for allowing vapor to flow upwardly through the tray deck to interact with the liquid on the upper surface. At least one can (34) extends upwardly from the tray deck and is formed by a perimeter wall (36). A downcomer (46) is interposed within the can to provide a passageway for liquid and has an upper inlet (50)for liquid entry, and a lower outlet (54) above the tray deck (28) for feeding liquid into the can and onto the tray deck. A plurality of deflector blades (56) are positioned above the tray deck to induce a swirling movement in the vapor ascending into the can. The portion of the tray deck surrounded by the perimeter wall of the can contains sieve holes, valves or other types of vapor passages. The tray may further include a sleeve (76), a plurality of cans (34) of two or more sizes or combinations thereof.

### CROSS REFERENCE TO RELATED APPLICATION

This application claims the benefit of provisional application Serial No. 60/391,483 filed Jun. 25, 2002.

### BACKGROUND OF THE INVENTION

The present invention relates to mass transfer and heat exchange columns and, more particularly, to vapor-liquid contact trays used in such columns.

Various types of vapor-liquid contact trays have been developed to facilitate contact between ascending vapor streams and descending liquid streams in mass transfer and heat exchange columns. A plurality of such trays are normally placed in horizontally extending and vertically spaced apart relationship within an open internal region of the column. The trays contain a contacting area or active area having openings that permit vapor to pass upwardly through the tray deck for interaction with liquid flowing across the upper surface of the tray deck. The vapor-liquid interaction that occurs above the active area of the deck forms a froth that facilitates the desired mass transfer and/or heat exchange. Most types of trays also contain larger openings and associated structures referred to as downcomers that allow the liquid to be removed from the tray deck after interaction with the ascending vapor. The liquid is directed downwardly through the downcomer to a normally imperforate liquid receiving or inlet area on the underlying tray.

One type of vapor-liquid tray that has been developed for high capacity and high efficiency applications is illustrated in U.S. Pat. No. 5,626,799 to Sheinman. The tray depicted in that patent uses a plurality of cylindrical cans that extend upward from the tray deck. A smaller diameter downcomer is centrally positioned within each cylindrical can to remove liquid from the overlying tray for discharge onto the tray deck within the cylindrical can. Swirl vanes are positioned in the tray deck to allow vapor to ascend through the tray deck with a swirling motion. As the swirling vapor contacts the liquid that has been discharged from the downcomer, it causes vigorous vapor-liquid interaction that leads to high separation efficiency. The swirling vapor also causes the liquid to be splashed against the inner surface of the cylindrical can, where it passes through vertical and horizontal slots provided in the wall of the can. The liquid then descends onto the tray deck and enters a downcomer inlet for passage to the next underlying tray. The vapor exits the open top of the cylindrical can and then passes through the swirl vanes in the overlying tray deck.

While the tray depicted in the Sheinman represents a significant advance over other types of vapor-liquid contact trays, additional improvements are desirable.

### SUMMARY OF THE INVENTION

In one aspect, the invention is directed to a vapor-liquid contact tray with a tray deck with at least one opening for removing liquid from an upper surface, a plurality of vapor passages for allowing vapor to flow upwardly through the tray deck to interact with the liquid on the upper surface of a tray deck, and at least one can extending upwardly from the tray deck and formed by a perimeter wall. A downcomer is interposed within each can to provide a passageway for liquid and has an upper inlet for liquid entry and a lower outlet above the tray deck for feeding liquid into the can and onto the tray deck. The tray also has plurality of deflector blades positioned above the tray deck to induce a swirling movement in the vapor ascending within the can. The tray deck may further include a sleeve received at the lower end of the downcomer to space the downcomer outlet a fixed distance above the tray deck. The vapor passages in that portion of the tray deck surrounded by the perimeter wall of the can are sieve holes, valves, openings between angled blades formed in the tray deck, or other types of vapor passages. The angled blades may be punched into a plurality of superimposed plates. When a plurality of cans are provided, they may be of two or more sizes. In addition, the deflector blades may be oriented to induce opposite rotational flow of vapor in selected ones of the cans. The deflector blades can be attached to the perimeter wall of the cans. The downcomer inlet can be of greater horizontal cross section that the downcomer outlet. The inlet area of the tray deck underlying the downcomer outlet can also elevated with the vapor passages provided in the walls connecting the inlet area with the underlying tray deck. The perimeter wall of the can contains liquid passages having a preselected configuration and arrangement. In one embodiment, the liquid passages are positioned above the level of liquid on the surrounding tray deck and are configured as two or more rows of triangular-shaped louvers.

In another aspect, the invention is directed to a method of intermixing vapor and liquid streams in a mass transfer column using the vapor-liquid contact trays described above. The invention is also directed to a mass transfer column containing such trays.

### BRIEF DESCRIPTION OF THE DRAWING

In the accompanying drawings which form part of the specification and are to be read in conjunction therewith and in which like reference numerals are used to indicate like parts in the various views:

FIG. 1 is a side elevation view of a column taken in vertical section to illustrate contact trays of the present invention positioned within an open internal area of the column;

FIG. 2 is a top plan view of a portion of a contact tray containing a cylindrical can and a downcomer and taken in horizontal section along line 2-2 of FIG. 1 on a reduced scale;

FIG. 3 is a top plan view similar to that shown in FIG. 2 but illustrating an alternate placement of deflector blades;.

FIG. 4 is fragmentary top plan view of a rotation-inducing element positioned within an outlet of one of the downcomers;

FIG. 5 is a fragmentary top plan view of the contact tray and showing a plurality of sieve holes in an active area of the tray deck and taken along line 5-5 of FIG. 1;

FIG. 6 is a fragmentary side elevation view of a perimeter wall of the can and showing triangular liquid passages;

FIG. 7 is a vertical section view of the can perimeter wall shown in FIG. 6;

FIG. 8 is a fragmentary side elevation view of the perimeter wall of the can showing an alternate embodiment of the liquid passages;

FIG. 9 is a vertical section view of the perimeter wall shown in FIG. 8;

FIG. 10 is a fragmentary side elevation view of the perimeter wall of the can showing a still further embodiment of the liquid passages;

FIG. 11 is a vertical section view of the perimeter wall shown in FIG. 10;

FIG. 12 is a fragmentary side elevation view of the contact tray showing additional features of the invention;

FIG. 13 is a fragmentary side elevation view of the downcomer and taken in vertical section to illustrate a horizontal discharge plate at the outlet of the downcomer;

FIG. 14 is a fragmentary top plan view of the contact tray showing an alternate embodiment of the downcomer inlet;

FIGS. 15-17 are fragmentary side elevation views showing variations of the downcomer;

FIG. 18 is a top plan view of the contact tray with flow lines representing the induced rotational direction of liquid flow within each can;

FIG. 19 is a perspective view, shown somewhat schematically, of the vapor liquid contact trays illustrating a deentrainment ring;

FIG. 20 is a fragmentary side elevation view of the vapor liquid contact trays illustrating a deentrainment cone;

FIG. 21 is a side elevation view of a flow deflector blade;

FIG. 22 is an exploded perspective view of an arrangement of plates containing vapor passages and blades for positioning within the lower edge of the can perimeter wall;

FIG. 23 is a perspective view of an alternate embodiment of the can;

FIG. 24 is a fragmentary, side elevation view of an alternate embodiment of a liquid contact tray having an elevated inlet area; and

FIG. 25 is a fragementary, side elevation view showing an alternate embodiment of the liquid contact tray shown in FIG. 12.

### DETAILED DESCRIPTION OF THE INVENTION

Referring now to the drawings in greater detail and initially to FIG. 1, a column suitable for use in mass transfer and heat exchange processes is represented generally by the numeral 20. Column 20 includes an upright, external shell 22 that is generally cylindrical in configuration, although other configurations, including polygonal, are possible and are within the scope of the invention. Shell 22 is of any suitable diameter and height and is constructed from one or more suitably rigid materials that are preferably inert to, or otherwise compatible with, the fluids and conditions present within the column 20.

Column 20 is of a type used for processing fluid streams, typically liquid and vapor streams, to obtain fractionation products and/or to otherwise cause mass transfer or heat exchange between the fluid streams. The shell 22 of the column 20 defines an open internal area 24 in which the desired mass transfer and/or heat exchange between the fluid streams occurs. Normally, the fluid streams comprise one or more descending liquid streams and one or more ascending vapor streams. Alternatively, the fluid streams may both be liquid streams or a gas stream and a liquid stream.

The fluid streams can be directed to the column 20 through any suitable number of feed lines positioned at appropriate locations along the height of the column 20. It will also be appreciated that one or more vapor streams can be generated within the column 20 rather than being introduced into the column 20 through one of the feed lines. The column 20 will also typically include an overhead line for removing a vapor product or byproduct and a bottom stream takeoff line for removing a liquid product or byproduct from the column 20. The various feed and removal lines, as well as other column components that are typically present, such as reflux stream lines, reboilers, condensers, vapor horns and the like, are not illustrated in the drawings because they are conventional in nature and are not believed to be necessary for an understanding of the present invention.

In accordance with the present invention, a plurality of horizontally extending contact trays 26 are positioned in vertically spaced apart relationship within the open internal region 24 of the column 20. The contact trays 26 include a tray deck 28 constructed from individual panels 30 having upturned flanges 32 positioned along opposite sides of the panels 30 to facilitate joinder of adjacent panels 30 using suitable fasteners (not shown). The contact trays 26 also include a plurality of spaced apart cylindrical cans 34 extending upwardly from and supported by the tray deck 28. The cans 34 are each open at the top and bottom and are formed by a cylindrical perimeter wall 36 having an upper edge 38 spaced a preselected distance below the overlying tray deck 28. It will be appreciated that configurations other than cylindrical can be utilized for some or all of the cans 34. A ring-shaped baffle 40 with a downwardly-curved cross section is spaced slightly above the upper edge 38 of the can 34 and serves to capture liquid flowing upwardly along the inner surface of the can 34 and cause it to be redirected in a downward direction outside of the can 34. The perimeter wall 36 of each can 34 also contains liquid passages 42 that allow liquid to pass outwardly through the perimeter wall 36 from within the can 34. In order to accommodate vapor entry into the cans 34 for interaction with liquid therein, vapor passages 44 are provided on that portion of the tray deck 28 within the area circumscribed by a lower edge 45 of each can 34.

Liquid is delivered to the cans 34 by a plurality of downcomers 46 that are interposed among the cans 34 on the tray deck 28 and provide a passageway for liquid to be removed from the tray deck 28 of one contact tray 26 and delivered to the tray deck 28 of one of the underlying contact trays 26, normally the immediately underlying contact tray 26. The downcomers 46 each comprise a wall 48 that is normally of cylindrical configuration and has an upper inlet 50 that surrounds an opening 52 (FIGS. 14-17) on the overlying tray deck 28 and a lower outlet 54 that is spaced a preselected distance above the tray deck 28 on the underlying contact tray 26. The downcomer inlets 50 are preferably positioned equidistant from a surrounding grouping of cans 34 on the tray deck 28. The downcomers 46 and cans 34 on vertically adjacent trays are arranged so that each downcomer 46 extends downwardly from one tray deck 28 and is centrally positioned within one of the cans 34 on the underlying tray deck 28. In this manner, the downcomers 46 remove liquid from one tray deck 28 and feed it downwardly into the cans 34 on the underlying tray deck 28.

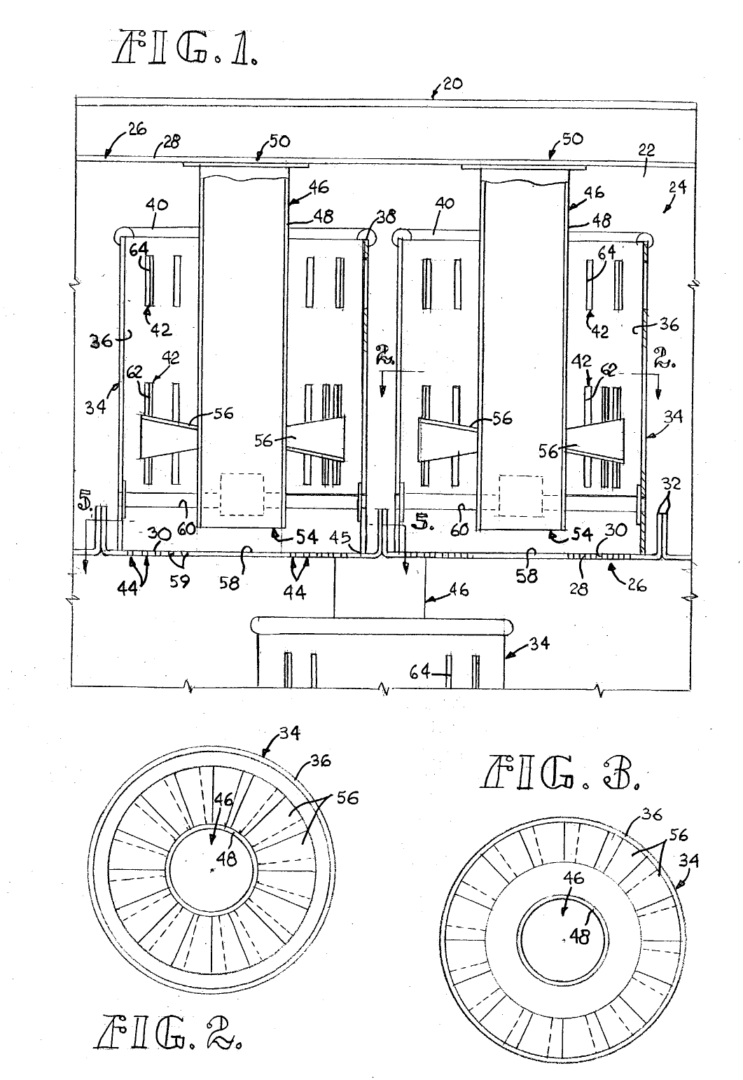

Turning additionally to FIG. 2, a plurality of swirl-inducing deflector blades 56 are attached to and extend radially outward from the outer surface of each downcomer wall 48. The deflector blades 56 are positioned a preselected distance above the tray deck 28, with the vertical placement being selected so that the deflector blades 56 will be positioned close to the froth level within the can 34 during normal operating conditions. The deflector blades 56 have a radial length which is less than the radial distance between the downcomer wall 48 and the perimeter wall 36 of the can 34 so that an annular space exists between the outer ends of the deflector blades 56 and the perimeter wall 36. The deflector blades 56 are spaced apart along the circumference of the cylindrical downcomer wall 48 and extend at an angle to the horizontal to induce a swirling, centrifugal movement in the vapor ascending within the associated can 34. This rising and swirling vapor causes liquid within the can 34 to be thrown against and lifted upwardly along the inner surface of the perimeter wall 36 of each can 34.

As can best be seen in FIG. 3, the deflector blades 56 need not be attached to the downcomer wall 48 but can instead extend radially inwardly from the perimeter wall 36 of the can 34. In this embodiment, the radially outer ends of the deflector blades 56 are attached directly to the perimeter wall 36 of the can 34, thereby eliminating any open annular space at the perimeter wall 36 that would allow vapor and liquid to bypass the deflector blades 56. Placement of the deflector blades 56 in this manner increases the swirling action imparted to the ascending vapor since most of the vapor flow is near the can perimeter wall 36. The attachment of the deflector blades 56 to the perimeter wall 36 provides the added benefit of funneling the liquid lifted by the vapor into discrete streams that are better able to resist undesired reentrainment of liquid in the vapor stream. The liquid impinging against the deflector blades 56 is also able to travel radially outwardly along the blades 56 to the perimeter wall 36 with reduced risk of reentrainment.

Referring now to FIGS. 1 and 5, the vapor enters the cans 34 through the vapor passages 44 provided in the area of the tray deck 28 within the perimeter of each can 34. An inlet area 58 underlying each downcomer outlet 54 is normally imperforate and free of the vapor passages 44 so that the force of the liquid discharged downwardly from the downcomer 46 does not cause liquid to weep through the tray deck 28. Previously, it was thought to be necessary to impart horizontal and tangential directional flow vectors to the vapor as it enters the cans 34 through the tray deck 28 so that the liquid discharged from the downcomer 46 could be pushed outwardly and upwardly against the inner surface of the can perimeter walls 36. Radially extending blades were then formed in the tray deck 28 in order to obtain the desired flow vectors for the vapor. It has been discovered, however, that under sufficiently high liquid flow rates, the vapor does not induce appreciable swirl to the liquid, yet the mass transfer efficiency is not adversely affected by the lack of swirling movement. Contrary to prior practice, it is now believed that the radially extending blades in the tray deck 28 are unnecessary in certain applications and can be replaced with simple sieve holes 59 of the type depicted in FIG. 5. By forming the vapor passages 44 as appropriately-sized sieve holes 59, which can have a round, oval, square, rectangular or other shape, the fabrication costs for the tray deck 28 can be reduced and less weeping of the liquid through the tray deck 28 can result from the use of the smaller sieve holes 59. In addition, the sieve holes 59 produce smaller vapor bubbles with greater total surface area so that the froth quality, i.e. the vapor-liquid interaction, is enhanced. A further advantage to the use of sieve holes 59 is the pressure drop across the tray deck 28 is reduced in comparison to the conventional radially extending blades. The sieve holes 59 will normally be positioned in any suitable pattern and density in those areas of the tray deck 28 within the cans 34, but omitted from the inlet area 58 directly underlying the downcomer outlets 54. The areas of the tray deck 28 outside of the cans 34 normally contains no vapor passages 44 so that all or substantially all of the ascending vapor must flow upwardly through the cans 34.

As an alternative to forming the vapor passages 44 as simple sieve holes 59, various stationary or moveable valves (not shown) can be utilized. These valves can also be arranged and/or constructed in a manner to provide a radial or tangential push to the liquid exiting the downcomer outlets 54. The location of the valves will be in the same or similar manner to the sieve holes described above.

In another embodiment illustrated in FIG. 24, the downcomer 46 is shortened and the imperforate inlet area 58 is elevated a preselected distance above the plane of the tray deck 28 to increase the active area of the tray deck 28 by allowing vapor flow in that portion of the tray deck 28 underlying the inlet area 58. The elevated inlet area 58 is held in place by an optional perforated vertical wall 59 of cylindrical or other desired configuration. Alternatively, the inlet area 58 can be held in place by other support structures (not shown). The tray deck 28 underlying the elevated inlet area 58 can be open or perforated and the downcomer outlet 54 can be completely open or partially closed by a perforated plate of a type to be subsequently described with reference to FIG. 13. Vapor which flows upwardly through that portion of the tray deck 28 underlying the elevated inlet area 58 impacts against the underside of the inlet area 58 and is advantageously redirected horizontally in a radially-outward direction.

As best shown in FIG. 1, the liquid passages 42 in the perimeter walls 36 of the cans 34 comprise a circumferential slot 60 positioned in a horizontal plane elevated a preselected distance above the downcomer outlet 54, and two groupings of vertically extending slots 62 and 64 positioned above the circumferential slot 60. The lowermost grouping of slots 62 are positioned in spaced-apart, side-by-side and parallel relationship with each other and are arrayed around the circumference of the perimeter wall 36. The uppermost grouping of slots 64 are likewise positioned in spaced-apart, side-by-side and parallel relationship to each other. The lowermost slots 62 are generally longer than the uppermost slots 64, but that need not necessarily be the case.

It has been discovered that under high liquid flow rates or other conditions that cause a liquid head to build up on the tray deck 28 outside of the cans 34, liquid can be forced back into the cans 34 through the circumferential slot 60. This situation is generally undesirable because it reduces the liquid capacity and separation efficiency of the contact trays 26. In order to prevent or reduce this unwanted movement of the liquid into the cans 34, the liquid passages 42 are preferably positioned above the level of the liquid on the surrounding tray deck 28. In order to facilitate manufacturing efficiency, a collar or other device (not shown) can be applied to close those liquid passages 42 lying below the level of the liquid. Alternatively, the unwanted liquid passages 42, such as the circumferential slot 60 and, optionally, the lowermost grouping of vertical slots 62, can be simply omitted during the manufacture of the cans 34. Thus, in some applications, only the uppermost grouping of vertical slots 64 will be utilized to permit liquid to exit the can perimeter wall 36, while in other applications both the uppermost and lowermost grouping of vertical slots 64 and 62 will be present. In a still further variation, the circumferential slot 60 will also be utilized, but will be elevated above the designed liquid level on the surrounding tray deck 28.

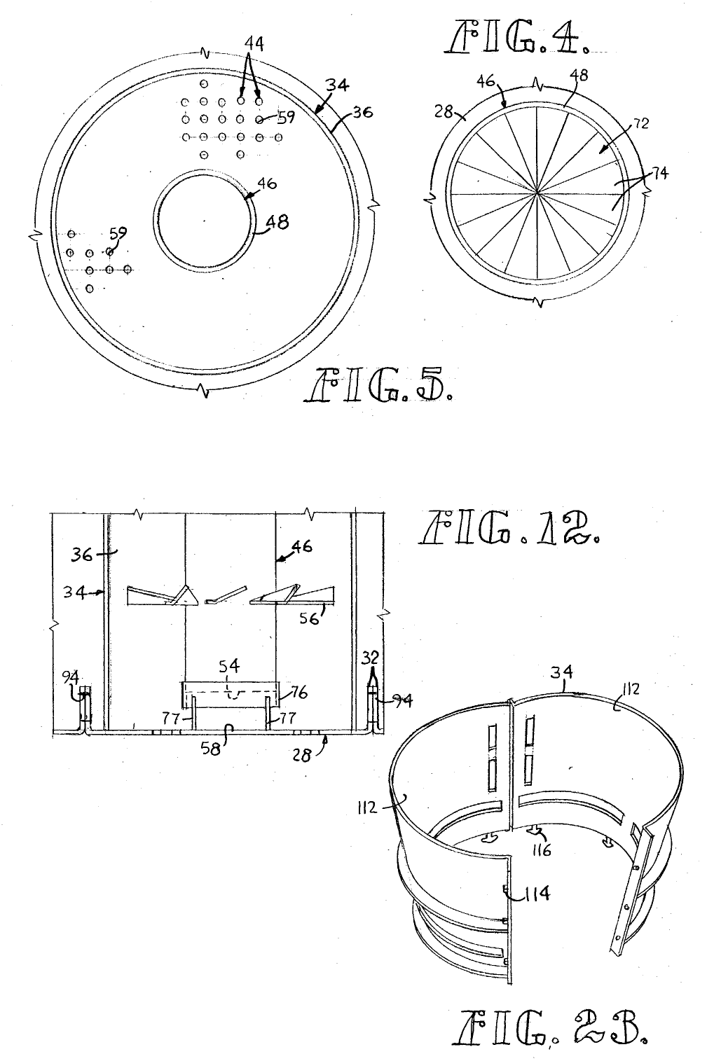

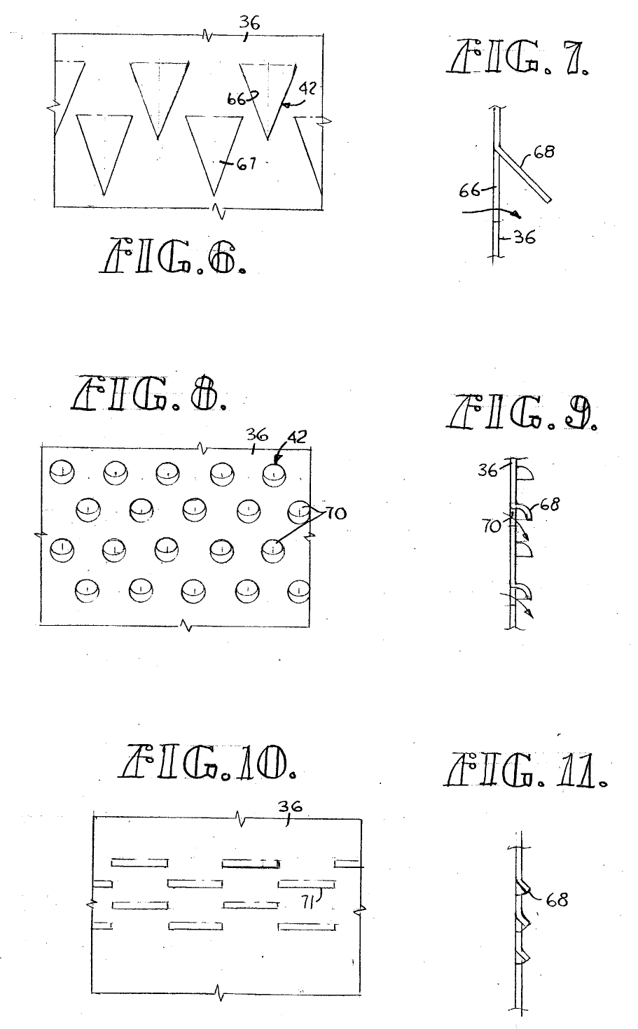

Portions of the liquid rising along the inner surface of the perimeter walls 36 of the cans 34 do not enter any of the vertical slots 62 and 64 because of the spacing between the slots 62 and 64. Although some of this liquid is captured by the baffle 40 and redirected downwardly outside the cans 34, other portions of this liquid become reentrained in the vapor. This reentrainment is undesirable because it reduces the capacity and efficiency of the contact trays 26. To reduce the opportunity for the liquid to bypass the liquid passages 42, the present invention contemplates that the liquid passages 42 are configured and positioned in a manner so that there are few or no flow paths along the intermediate and upper portions of the can perimeter wall 36 that do not contain at least one liquid passage 42. For example, as shown in an embodiment depicted in FIG. 6, the liquid passages 42 comprise two or more rows of triangular-shaped openings 66 that are oriented with their apex at the bottom. The openings 66 in one row are offset from the openings 67 in the vertically adjacent row and are sized so that liquid cannot travel upwardly along a straight line, whether vertical or at some angle to the vertical, without being intercepted by a portion of at least one opening 66 and 67 in one or both rows. It will be appreciated that multiple rows of openings 66 and 67 may be used, with greater spacing between the openings in each row. Increasing the spacing between the openings 66 and 67 within each row is generally desirable because too much open area can lead to weakening of the mechanical strength of the perimeter wall 36.

The triangular openings 66 and 67 can also be formed as louvres, as shown in FIG. 7, wherein a deflector 68, preferably formed by punching the opening 66 or 67, is associated with some or all of the openings 66 and 67. The deflector 68 preferably forms a downwardly directed outlet so that liquid exiting the cans 34 through the openings 66 and 67 impacts against the deflectors 68 and is redirected in a downward direction onto that portion of the tray deck 28 outside of the cans 34. The deflectors 68 can be attached to the perimeter wall 36 along only their top edges or along their top edges and a portion or all of one or more of their sides.

The liquid passages 42 can also be shaped in configurations other than the triangular openings 66 and 67 depicted in FIG. 6. For example, the liquid passages 42 can be in the form of multiple rows or other arrangements of circular openings 70 with curved deflectors 68 as shown in FIGS. 8 and 9 or slots 71 with deflectors 68 extending horizontally or at some other angle to the vertical as shown in FIGS. 10 and 11. The liquid passages 42 are not limited to the specific embodiments illustrated in the drawings, but encompass other configurations that prevent liquid from ascending along a straight flow path without encountering at least one liquid passage 42.

The liquid discharged from the downcomer outlet normally impacts against the imperforate inlet area 58 with a downward momentum and is then redirected to flow horizontally along a radial or tangential flow path. The horizontally flowing liquid then intermixes with the vapor ascending through the vapor passages 44 to form a froth. As previously mentioned, it has been determined that it is not always necessary to use vapor horizontal and radial or tangential directional flow vectors to push the liquid outwardly and onto the perimeter wall 36 of the can 34. In some applications, it may be desirable to induce a tangential or rotational motion to the liquid as it exits the downcomer outlet 54 so that it travels along a curved flow path as it traverses across the tray deck 28 to the perimeter wall 36. By traveling along a curved rather than radial flow path, the liquid travels a greater distance and is in contact with and interacts with the vapor for a greater length of time, thereby enhancing the mass transfer and/or heat exchange occurring between the liquid and vapor phases. As shown in FIG. 4, this rotational liquid motion can be induced by placing a rotation-inducing element 72 comprising a plurality of radially extending guide vanes 74 in the downcomer outlet 54. The guide vanes 74 can be planar or curved, with at least a portion or all of some or all of the vanes extending at an angle to the vertical.

The liquid must exit the downcomer outlets 54 in sufficient quantities to provide a dynamic seal against vapor entry into the downcomers 46 through the outlets 54. Too much liquid flowing through the downcomers 46, however, will cause liquid to back up in the downcomers 46 and cause flooding of the contact trays 26. As a result, the open area available for liquid discharge from the downcomers 46 must be carefully controlled to provide the desired dynamic liquid seal without leading to harmful flooding. When this open area is defined by the vertical clearance between the downcomer outlet 54 and the tray deck 28, it can be difficult to maintain a consistent clearance because the tray deck 28 may sag in places, the rings that support the contact trays 26 may be vertically misaligned, and there may be size variations among the various tray components as a result of fabrication variances. Adjustment of this clearance using adjustable skirts can be problematic once the contact trays 26 have been installed because of the difficulty in obtaining access to the installed trays 26. In order to overcome this problem in one embodiment of the present invention illustrated in FIG. 12, a sleeve 76 is spaced a preselected distance above the inlet area 58 of the tray deck 28 within each can 34 by a plurality of vertical legs 77 extending between and fixed to the tray deck 28 and the sleeve 76. The sleeve 76 has an inner diameter which is slightly greater than the outer diameter of the downcomer 46 so that the lower end of the downcomer 46 can be closely received within the sleeve 76. The sleeve 76 thereby functions as an extension of the downcomer 46 and compensates for any variations in the relative positioning between the downcomer outlet 54 and the tray deck 28. The sleeve 76 has a vertical dimension sufficient to compensate for anticipated variations in the relative positioning between the downcomer outlet 54 and the inlet area 58. The sleeve 76 is positioned such that its lower edge is a preselected distance above the tray deck 28, thereby providing the desired, fixed clearance or open area between the downcomer outlet 54 and the tray deck 28 for liquid to exit from the downcomer 54. In this manner, liquid is able to exit through the designed open area below the fixed sleeve 76 even if the outlet 54 of the downcomer 54 itself is spaced further from the tray deck 28 than required by design specifications. In an alternative embodiment illustrated in FIG. 25, the support legs 77 are omitted and the sleeve 76 is fixed to the downcomer 46 and has a sufficient vertical length so that it is supported on the underlying tray deck 28. Rather than discharging liquid out of the bottom of the sleeve 76, the bottom is closed by the imperforate inlet area 58 or, more preferably, by a separate imperforate plate 78 fixed to the bottom of the sleeve 76. Discharge openings 79 having a preselected open area are provided in the side wall of the sleeve 76 to allow liquid to exit the downcomer 46 with a desirable horizontal flow direction. Because the open area of the discharge openings 79 is fixed and unaffected by variations in spacing between the downcomer outlet 54 and the tray deck 28, the opportunity for flooding of the downcomers 46 or vapor entry into the downcomers 46 is reduced.

The open area for discharge of liquid from the downcomer 46 onto the tray deck 28 can also be fixed by placement of a horizontally-extending plate 80 containing one or more openings 82 across the downcomer outlet 54, as shown in FIG. 13. The total area of the openings 82 is preselected and fixed so that liquid is able to accumulate within the downcomer 46 to form a dynamic seal against vapor entry without causing flooding of the contact trays 26. The openings 82 can be simple sieve holes, or they can be fixed or floating valves. The floating valves move up and close when vapor attempts to enter the downcomer outlet 54.

The liquid handling capacity of the downcomers 46 can be increased by increasing the size of the downcomer inlet 50 in relation to the downcomer outlet 54. As can be seen in FIGS. 14 to 17, this can be accomplished in various fashions. In FIG. 15, the downcomer wall 48 slopes uniformly inwardly from the wider inlet 50 to the narrower outlet 54. In FIG. 16, the downcomer wall 48 has a wider upper segment 84 and a narrower lower segment 86 connected together by an sloped intermediate segment 88. The upper and lower segments 84 and 86 can independently be of cylindrical, square or other cross section. In FIG. 17, the upper segment 84 and lower segment 86 are connected in a stair-stepped arrangement using a right angle flange 90. As can be seen in FIG. 14, forming the upper segment 84 of the downcomers 46 with a square cross section allows the inlet 50 to occupy more of the tray deck 28 in the available spacing between the cylindrical cans 34.

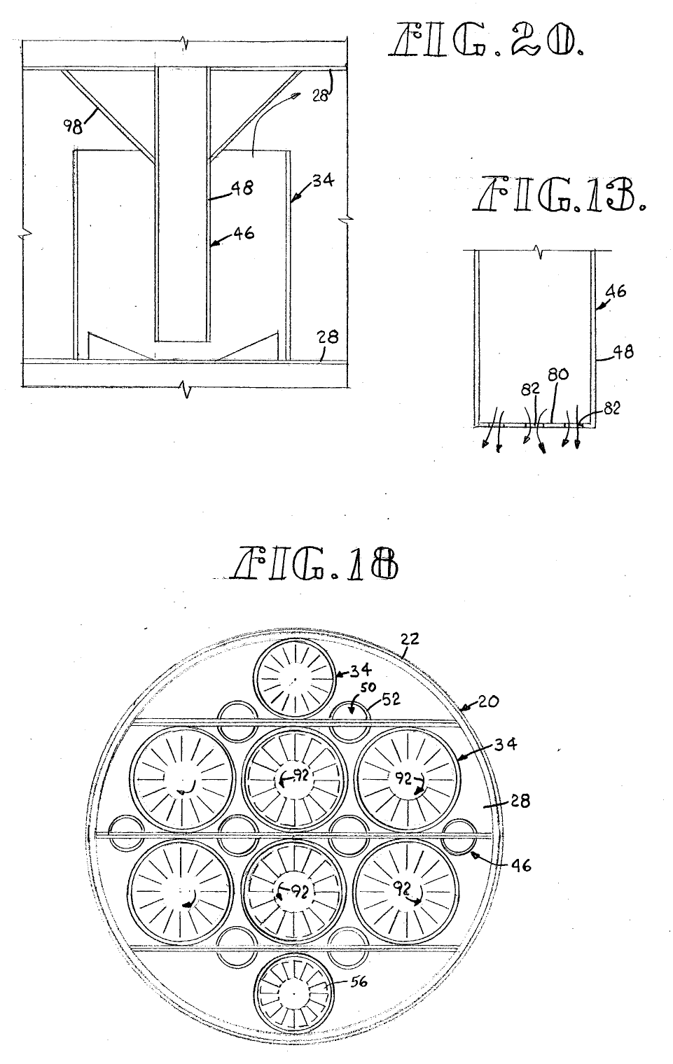

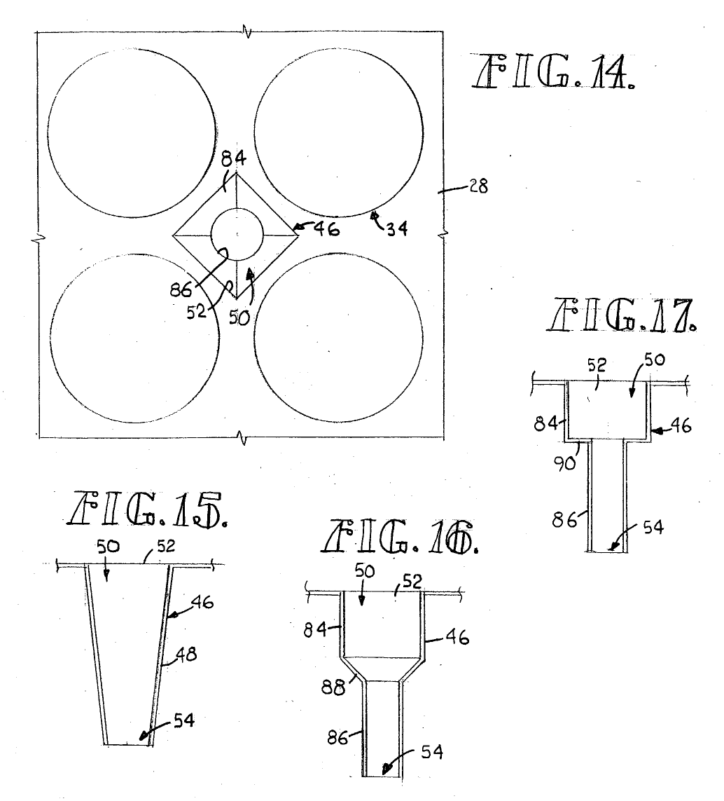

As can be seen in FIG. 18, the cans 34 arrayed across the tray deck 28 need not all be of the same size or construction. Some of the cans 34 may be smaller than others to better utilize the space available on the tray deck 28. The smaller cans 34 also don't necessarily need to have the same construction as the larger cans 34. For example, the smaller cans 34 can be simple swirl tubes or other conventional contacting devices. The direction of liquid and vapor rotational flow within the cans 34 also can be varied among the cans 34. This can be achieved in various fashions, such as by changing the orientation of the guide vanes 74 in the rotation-inducing element 72 in selected cans 34, by changing the rotational direction of vapor entering selected cans 34 through the tray deck 28, and/or by changing the orientation of the deflector blades 56 in selected cans 34. In a preferred embodiment, the direction of rotational flow within each can 34 in each grouping of cans 34 that surround a common downcomer inlet 50 is selected to facilitate flow of liquid into the downcomer inlet 50. In a grouping of four cans 34 that feed a common inlet 50, the vapor and liquid rotational direction in each can 34 is the same as the rotational direction in one of the adjacent cans 34 and opposite to the rotational direction in the other adjacent can 34. This arrangement is schematically illustrated using clockwise and counterclockwise liquid flow lines 92.

The upturned flanges 32 constrain the liquid mixing and movement on the tray deck 28 and limit the locations suitable for placement of the cans 34 on the tray deck 28. Placement of spaced apart openings 94 (FIG. 12) along the length of the flanges 32 allows liquid to pass through the flanges 32 for mixing with liquid on opposite sides of the flanges. Another approach to permitting greater mixing of the liquid and greater flexibility in the placement of the cans 34 involves constructing the tray panels 30 in a fashion so that the flanges 32 extend downwardly below the tray deck 28. In one embodiment, the flanges 32 would be constructed so that they interlock and can be installed without requiring that the installer have access to the underside of the tray panels 30. This can be accomplished by placing slots in one of each pair of flanges 32 and interlocking, joggled fingers in the other of the paired flanges 32. A removable locking fastener, such as the nut and bolt fasteners commonly used to join tray panels, can then be used to prevent separation of the panels 30. The depending flanges 32 in this arrangement would provide the added benefit of providing a liquid deentrainment surface against which some of the ascending vapor would contact as it travels between the cans 34 on an underlying contact tray 26 and the vapor passages 44 in the overlying tray deck. Some or all of the liquid entrained with the vapor that contacts the flanges 32 will then collect on the flanges 32 and separate from the vapor stream.

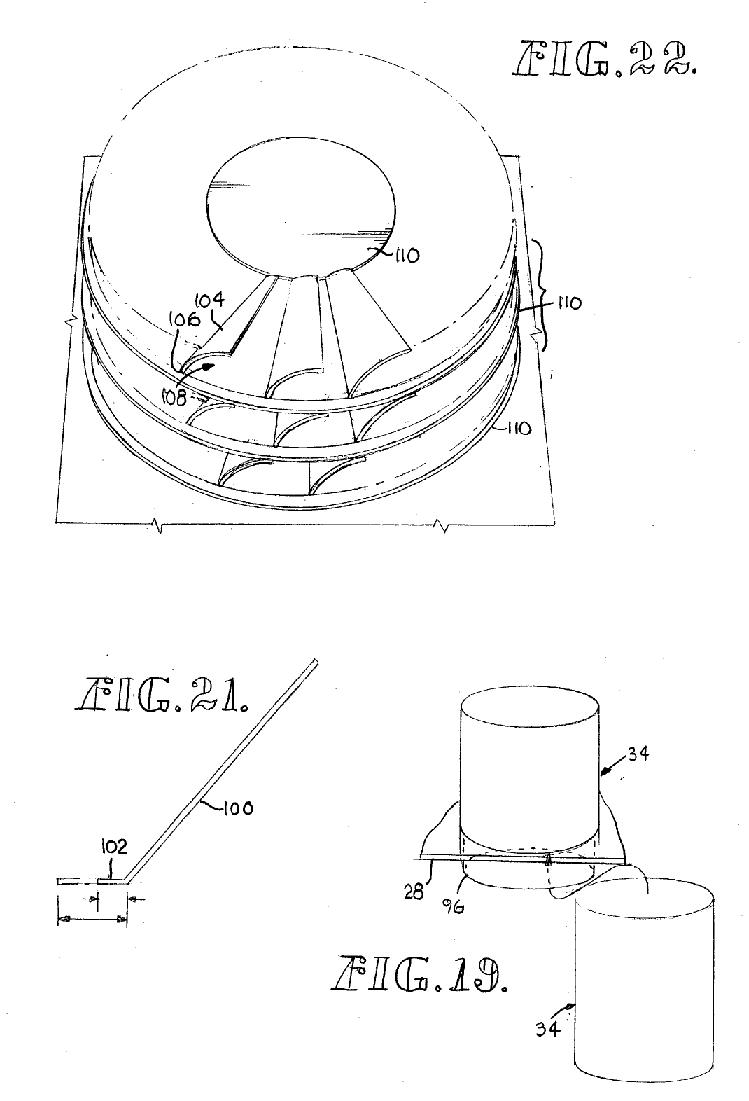

Liquid deentrainment can also be achieved by placing a circular ring 96 under the tray deck 28 in vertical alignment with one or more of the cans 34 positioned above the tray deck 28, as shown somewhat schematically in FIG. 19. The rings 96 are preferably of the same diameter as the associated cans 34, but can have a greater or even a lesser diameter if desired. The rings 96 serve to disrupt the horizontal flow of the vapor and provide an impingement surface that facilitates deentrainment of liquid from the vapor stream. Rather than using complete rings 96 to cause liquid deentrainment, partial rings may be used, with the ring segments from a grouping of cans 34 being connected to form a unitary structure. In another variation, liquid entrainment can be reduced by placement of an inverted cone 98 above some or all of the cans 34 as illustrated in FIG. 20. The cone 98 can be secured to the undersurface of the overlying tray deck 28 and has a central opening sized to allow the downcomer 46 to extend downwardly through the cone 98.

When the vapor passages 44 comprise radially extending angled blades 100 as shown in FIG. 20, the pressure drop across the blades 100 can be reduced by shortening the horizontal dimension of a leading edge 102 of each blade 100 as depicted in FIG. 21. Further reductions in pressure drop can be accomplished by using curved blades 104 which present a leading edge 106 having the thickness of the material used for the blades 104, as shown in FIG. 22. The curved blades 104 also provide narrowing flow channels 108 which increase the vapor velocity and provide a better froth quality. The blades 104 can be welded to a hub and spaced ring or, as illustrated in FIG. 22, the blades 104 can be punched in a plurality of plates 110 which are then superimposed in contact with each other to provide the desired number of and spacing between individual blades 104.

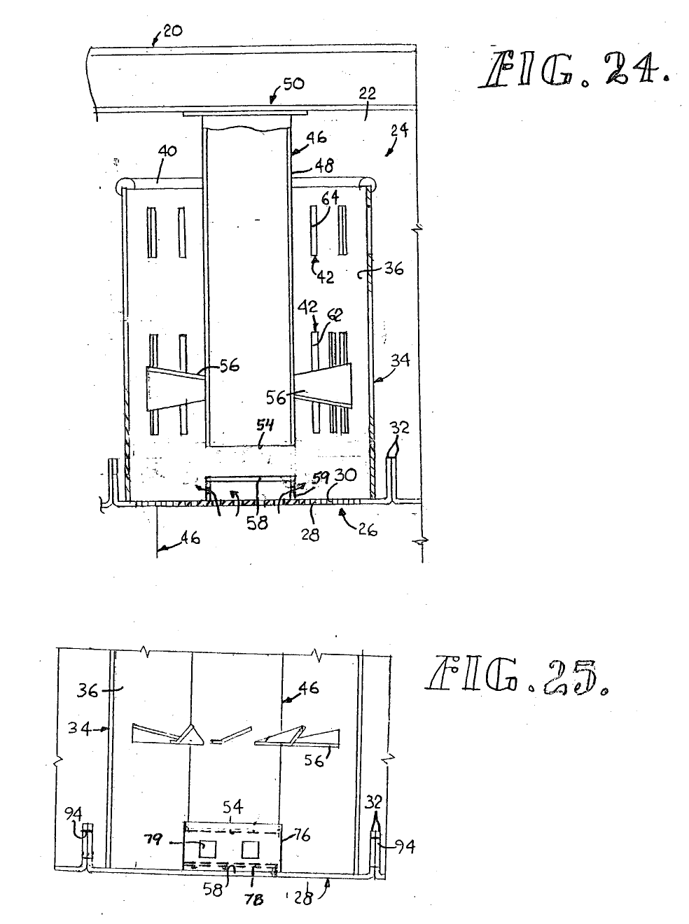

Turning to FIG. 23, the cans 34 can be of a clamshell design that allows the cans 34 to be more easily assembled and disassembled. Forming the cans 34 as two or more segments 112 joined together by removable fasteners 114 allows the cans 34 to be assembled around already installed downcomers 46 as well as removed from around installed downcomers 46. The cans 34 include bayonet-type mounts 116 that allow the cans 34 to be readily secured to slots in the tray deck 28. Other mounting devices can also be used.

From the foregoing, it will be seen that this invention is one well adapted to attain all the ends and objectives hereinabove set forth together with other advantages which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative and not in a limiting sense.

Having thus described the invention, what is claimed is:

1. A vapor-liquid contact tray comprising:
a tray deck having at least one opening for removing liquid from an upper surface of the tray deck and a plurality of vapor passages for allowing vapor to flow upwardly through the tray deck to interact with the liquid on the upper surface;
at least one can extending upwardly from the tray deck and formed by a perimeter wall, said can being positioned in surrounding relationship to at least some of said vapor passages;
at least one downcomer extending downwardly within said at least one can and providing a passageway for liquid, said downcomer having an upper inlet for receiving liquid and a lower outlet spaced above the tray deck for feeding liquid into the can and onto the tray deck; and
a plurality of deflector blades, positioned above the tray deck within the at least one can and oriented to induce a swirling movement in the vapor ascending within the at least one can,
wherein said vapor passages are selected from the group consisting of sieve holes and valves.

2. The contact tray of claim 1, wherein an area of said tray deck underlying and in vertical alignment with the downcomer outlet is imperforate.

3. The contact tray of claim 1, wherein the vapor passages are sieve holes.

4. The contact tray of claim 1, wherein the vapor passages are valves.

5. The contact tray of claim 1 wherein the deflector blades are attached to the perimeter wall of said at least one can.

6. The contact tray of claim 1, further comprising:
an elevated inlet area above a plane of the tray deck and underlying the downcomer outlet, said elevated inlet are being joined to the tray deck by walls containing vapor passages.

7. The contact tray of claim 6, wherein the elevated inlet area is imperforate.

8. The contact tray of claim 1, wherein the perimeter walls of the at least one can has one or more liquid passages to permit liquid to exit the can, wherein the liquid passages are positioned above a level of the liquid on the surrounding tray deck.

9. The contact tray of claim 8, wherein the liquid passages along intermediate and upper portions of the can perimeter wall comprise two or more rows of triangular-shaped louvres that are oriented with their apex at the bottom.

10. The contact tray of claim 1, further comprising:
a plurality of radially extending guide vanes in the downcomer outlet.

11. The contact tray of claim 1, further comprising:
a sleeve fixed to and upstanding from the tray deck and at least partially overlapping with a lower end of the downcomer, said sleeve providing at least one opening for discharging liquid exiting from said downcomer outlet.

12. The contact tray of claim 1, further comprising:
a horizontally-extending plate positioned across the downcomer outlet having one or more apertures.

13. The contact tray of claim 1, wherein the inlet of the downcomer has a larger horizontal cross section than the outlet of the downcomer.

14. The contact tray of claim 1, including a plurality of said cans positioned in a preselected pattern across said tray deck and wherein said cans are two or more sizes.

15. The contact tray of claim 14, wherein the deflector blades positioned within some of the cans are oriented to induce said swirling movement in one rotational direction and the deflector blades positioned within others of the cans are oriented to induce said swirling movement in an opposite rotational direction.

16. The contact tray of claim 1, wherein the tray deck is comprised of at least two panels joined together along downwardly extending flanges positioned on opposite sides of the panels.

17. The contact tray of claim 1, wherein the perimeter wall of the at least one can comprises two or more segments.

18. A mass transfer column comprising an external shell defining an interior region open to the flow of vapor and liquid streams and a plurality of vapor-liquid contact trays supported in the open internal region, at least one of the vapor-liquid contact trays comprising:
a tray deck having at least one opening for removing liquid from an upper surface of the tray deck and a plurality of vapor passages for allowing vapor to flow upwardly through the tray deck to interact with the liquid on the upper surface;
at least one can extending upwardly from the tray deck and formed by a perimeter wall, said can being positioned in surrounding relationship to at least some of said vapor passages;
at least one downcomer extending downwardly within said at least one can and providing a passageway for liquid, said downcomer having an upper inlet for receiving liquid and a lower outlet spaced above the tray deck for feeding liquid into the can and onto the tray deck; and
a plurality of deflector blades, positioned above the tray deck within the at least one can and oriented to induce a swirling movement in the vapor ascending within the at least one can,
wherein said vapor passages are selected from the group consisting of sieve holes and valves.

19. The mass transfer column as in claim 18, wherein the vapor passages are sieve holes.

20. The mass transfer column as in claim 18, wherein the vapor passages are valves.

21. A method of intermixing vapor and liquid streams in a mass transfer column having a plurality of vapor-liquid contact trays supported in the open internal region, at least one tray having a tray deck containing a plurality of vapor passages comprising either sieve holes or valves, at least one can having a perimeter wall, at least one downcomer interposed within the can, and a plurality of deflector blades positioned above the tray deck, the method comprising:
(a) flowing a liquid stream across the tray deck of one of the trays toward at least one opening in the tray deck;
(b) directing at least part of the liquid stream into an inlet of the downcomer;
(c) discharging substantially all of the part of liquid stream from the downcomer into the can of the underlying tray deck;
(d) passing a vapor stream upwardly through the vapor passages in the tray deck and into the can without inducing a swirling motion to the vapor stream as it passes through the vapor passages; and
(e) inducing a swirling movement in the vapor stream after it has passed through the vapor passages, wherein the swirling vapor stream causes the liquid in the can to be thrown against and lifted upwardly along an inner surface of the perimeter wall of the can.

22. A vapor-liquid contact tray comprising:
a tray deck having at least one opening for removing liquid from an upper surface of the tray deck and a plurality of radially extending blades formed in the tray deck to induce a swirling movement in the vapor flowing upwardly through the tray deck to interact with the liquid on the upper surface;
at least one can extending upwardly from the tray deck and formed by a perimeter wall;
at least one downcomer extending downwardly within said at least one can and providing a passageway for liquid, said downcomer having an upper inlet for receiving liquid and a lower outlet spaced above the tray deck for feeding liquid into the can and onto the tray deck;
a plurality of deflector blades, positioned above the tray deck within the at least one can and oriented to induce a swirling movement in the vapor ascending within the at least one can; and
a sleeve fixed to and upstanding from the tray deck and at least partially overlapping with a lower end of the downcomer, said sleeve providing at least one opening for discharging liquid exiting from said downcomer outlet.

23. The contact tray of claim 22, wherein the sleeve is supported by one or one or more legs extending between the tray deck and the sleeve.

24. The contact tray of claim 22, wherein the sleeve is supported by the underlying tray deck.

25. The contact tray of claim 22, wherein the sleeve is closed by an imperforate inlet area and includes discharge openings in the side wall of the sleeve.

26. A mass transfer column comprising an external shell defining an interior region open to the flow of vapor and liquid streams and a plurality of vapor-liquid contact trays supported in the open internal region, at least one of the vapor-liquid contact trays comprising:
a tray deck having at least one opening for removing liquid from an upper surface of the tray deck and a plurality of radially extending blades formed in the tray deck to induce a swirling movement in the vapor flowing upwardly through the tray deck to interact with the liquid on the upper surface;
at least one can extending upwardly from the tray deck and formed by a perimeter wall;
at least one downcomer extending downwardly within said at least one can and providing a passageway for liquid, said downcomer having an upper inlet for receiving liquid and a lower outlet spaced above the tray deck for feeding liquid into the can and onto the tray deck;
a plurality of deflector blades, positioned above the tray deck within the at least one can and oriented to induce a swirling movement in the vapor ascending within the at least one can; and
a sleeve fixed to and upstanding from the tray deck and at least partially overlapping with a lower end of the downcomer, said sleeve providing at least one opening for discharging liquid exiting from said downcomer outlet.

27. A method of intermixing vapor and liquid streams in a mass transfer column having a plurality of vapor-liquid contact trays supported in the open internal region, at least one tray having a plurality of radially extending blades formed in the tray deck, at least one can having a perimeter wall, at least one downcomer interposed within the can with a sleeve received at the lower end of the downcomer and a plurality of deflector blades positioned above the tray deck, the method comprising:
(a) flowing a liquid stream across the tray deck of one of the trays toward at least one opening in the tray deck;
(b) directing at least part of the liquid stream into an inlet of the downcomer;
(c) discharging substantially all of the part of liquid stream from the downcomer through the sleeve and into the can of the underlying tray deck;
(d) passing vapor stream upwardly through the vapor passages in the tray deck and into the can; and
(e) inducing a swirling movement in the vapor stream, wherein the swirling vapor stream causes the liquid in the can to be thrown against and lifted upwardly along the inner surface of the perimeter wall of the can.

28. A vapor-liquid contact tray comprising:
a tray deck having at least one opening for removing liquid from an upper surface of the tray deck and a plurality of radially extending angled blades formed in the tray deck, wherein the leading edges of the angled blades have a shortened horizontal dimension and the angled blades induce a swirling movement in the vapor flowing upwardly through the tray deck to interact with the liquid on the upper surface;
at least one can extending upwardly from the tray deck and formed by a perimeter wall;
at least one downcomer interposed within at least one can and providing a passageway for liquid, said downcomer having an upper inlet for receiving liquid and a lower outlet spaced above the tray deck for feeding liquid into the can and onto the tray deck; and
a plurality of deflector blades, positioned above the tray deck within the at least one can.

29. The contact tray of claim 28, wherein the angled blades are curved.

30. The contact tray of claim 28, wherein the angled blades are punched into a plurality of stacked plates.

31. The contact tray of claim 30, wherein the angled blades are superimposed in contact with each other.

32. A mass transfer column comprising an external shell defining an interior region open to the flow of vapor and liquid streams and a plurality of vapor-liquid contact trays supported in the open internal region, at least one of the vapor-liquid contact trays comprising:
a tray deck having at least one opening for removing liquid from an upper surface of the tray deck and a plurality of radially extending angled blades formed in the tray deck, wherein leading edges of the angled blades have a shortened horizontal dimension and the angled blades induce a swirling movement in the vapor flowing upwardly through the tray deck to interact with the liquid on the upper surface;
at least one can extending upwardly from the tray deck formed by a perimeter wall;
at least one downcomer interposed within at least one can to provide a passageway for liquid, having an upper, inlet for liquid and a lower outlet above the tray deck for feeding liquid into the can and tray deck; and
a plurality of deflector blades, positioned above the tray deck to induce a swirling movement in the vapor ascending into the can.

33. A method of intermixing vapor and liquid streams in a mass transfer column having a plurality of vapor-liquid contact trays supported in the open internal region, at least one tray having a plurality of radially extending blades formed in the tray deck, at least one can having a perimeter wall, at least one downcomer interposed within the can and a plurality of deflector blades positioned above the tray deck, the method comprising:
(a) flowing a liquid stream across the tray deck of one of the trays toward at least one opening in the tray deck;
(b) directing at least part of the liquid stream into an inlet of the downcomer;
(c) discharging substantially all of the part of liquid stream from the downcomer and into the can of the underlying tray deck;
(d) passing vapor stream upwardly through a plurality of radially extending angled blades formed in the tray deck, wherein the leading edges of the angled blades have a shortened horizontal dimension; and
(e) inducing a swirling movement in the vapor, wherein the swirling vapor causes the liquid in the can to be thrown against and lifted upwardly along the inner surface of the perimeter wall of the can.

34. A vapor-liquid contact tray comprising:
a tray deck having at least one opening for removing liquid from an upper surface of the tray deck and a plurality of radially extending angled blades formed in the tray deck to induce a swirling movement in the vapor flowing upwardly through the tray deck to interact with the liquid on the upper surface;
a plurality of cans extending upwardly from the tray deck formed by a perimeter wall, wherein the cans are two or more sizes;
at least one downcomer interposed within at least one can to provide a passageway for liquid, having an upper inlet for liquid and a lower outlet above the tray deck for feeding liquid into the can and tray deck; and
a plurality of deflector blades, positioned above the tray deck to induce a swirling movement in the vapor ascending into the can.

35. The contact tray of claim 34, wherein the rotational flow in the cans is varied among the cans.

36. The contact tray of claim 35, wherein the rotation flow within each can facilitates the flow of liquid into one or more openings for removing liquid from the tray deck.

37. A mass transfer column comprising an external shell defining an interior region open to the flow of vapor and liquid streams and a plurality of vapor-liquid contact trays supported in the open internal region, at least one of the vapor-liquid contact trays comprising:
a tray deck having at least one opening for removing liquid from an upper surface of the tray deck and a plurality of radially extending blades formed in the tray deck induce a swirling movement the vapor flowing upwardly through the tray deck to interact with the liquid on the upper surface;
a plurality of cans extending upwardly from the tray deck formed, wherein the cans are formed by a perimeter wall, wherein the cans are two or more sizes;
at least one downcomer interposed within at least one can to provide a passageway for liquid, having an upper inlet for liquid and a lower outlet above the tray deck for feeding liquid into the can and tray deck; and
a plurality of deflector blades, positioned above the tray deck to induce a swirling movement in the vapor ascending into the can.

38. A method of intermixing vapor and liquid streams in a mass transfer column having a plurality of vapor-liquid contact trays supported in the open internal region, at least one tray having a plurality of radially extending blades formed in the tray deck, a plurality of cans having a perimeter wall, at least one downcomer interposed within the can and a plurality of deflector blades positioned above the tray deck, the method comprising:
(a) flowing a liquid stream across the tray deck of one of the trays toward at least one opening in the tray deck;
(b) directing at least part of the liquid stream into an inlet of the downcomer;
(c) discharging substantially all of the part of liquid stream from one or more downcomers into the cans of the underlying tray deck;
(d) passing vapor stream upwardly through the vapor passages in the tray deck and into the cans;
(e) inducing a swirling movement in the vapor, wherein the swirling vapor causes the liquid in the cans to be thrown against and lifted upwardly along the inner surface of the perimeter walls of the cans; and
(f) directing the rotational flow within each can to facilitate the flow of liquid into one or more openings for removing liquid from the tray deck.
